(19) United States
(12) Patent Application Publication
(10) Pub. No.: US 2004/0137851 A1
(43) Pub. Date: Jul. 15, 2004

(54) Frequency offset controller

(76) Inventors: Mohammad Shahanshah Akhter, Kanata (CA); Michael Low, Kanata (CA); Chandra Mauli Singh, Ottawa (CA); Vajira Samarasooriya, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/694,763

(22) Filed: Oct. 29, 2003

Related U.S. Application Data
(60) Provisional application No. 60/421,809, filed on Oct. 29, 2002.

(51) Int. Cl. H04B 1/00

(52) U.S. Cl. 455/71

(57) ABSTRACT

A frequency offset controller using feedback, and an offset estimator are disclosed herein, as are methods for both. The estimator offset method can be used in satellite and terrestrial communications receivers. The methods can be used in receivers where the frequency offset is between 0% and 50% of the symbol rate.

### CROSS REFERENCE TO RELATED APPLICATIONS

This application claims the benefit of priority of U.S. Provisional Patent Application No. 60/421,809 filed Oct. 29, 2002 which is incorporated herein by reference.

### FIELD OF THE INVENTION

The present invention relates generally to the demodulation of frequency-shifted signals. More particularly, the present invention relates to the automated estimation and removal of frequency offset in a received signal.

### BACKGROUND OF THE INVENTION

In many communication systems, especially those utilising a terrestrial or satellite interface, it is common for a receiving station, such as a terminal or hub station, to receive a frequency offset baseband signal. This offset is commonly modelled as a phase rotation with respect to the receiver phase reference. The offset typically arises as a result of unmodelled irregularities in the transmission channel.

Because the offset is modelled as a phase rotation, it is common for the frequency correction to require estimation of the offset, and then multiplication of the received signal by the complex conjugate of the estimated offset. If the estimate of the offset is accurate, the baseband signal no longer contains a frequency offset. Inaccurate estimates of the offset result in a different, but hopefully reduced, offset value.

A signal that has been properly corrected to remove the frequency offset is more easily processed by other downstream receiver blocks, including the carrier phase recovery block. A variety of controllers are known, all of which can be implemented in a baseband receiver to estimate and remove the frequency offset in a received signal.

Many different techniques have been developed to derive the estimate of the offset. One such method involves performing Fast Fourier Transforms (FFT) on samples from the received signal. This technique provides very accurate estimates of the offset. However, one skilled in the art will appreciate that the computational complexity involved in FFT based operations and the memory required from these operations is considered to be prohibitive in many receiver systems.

As an alternate solution to the FFT based estimation, many systems employ a technique resembling the common binary-search algorithm. This technique involves the selection of endpoints for a range of possible frequency offsets. An intermediate value, between the boundaries, is then evaluated. If the first intermediate value is does not match the offset, a determination of whether the estimate over- or under-compensated for the offset is made. On the basis of this determination, the estimate becomes either the new upper or lower boundary, and a new estimate is selected so the process can be repeated. This process is iterative, and through it will converge on the desired offset, the rate of convergence is not ideal, which limits the speed at which a received signal can be synchronized. Moreover, the estimate often oscillates about the actual value, which is undesirable.

Typically, the techniques used in the art either suffer from poor convergence properties such as low speed or a high degree of oscillation, or are so computationally complex that their applicability is greatly limited. It is, therefore, desirable to employ a controller than can rapidly and accurately estimate the frequency offset in a received signal to allow for offset correction.

### SUMMARY OF THE INVENTION

It is an object of the present invention to obviate or mitigate at least one disadvantage of previous frequency offset controllers.

In a first aspect of the present invention there is provided a frequency offset controller for correcting a frequency offset in a transmitted signal, the offset equivalent to a phase rotation of the transmitted signal. The controller comprises a multiplier, a frequency estimator, and a signal generator. The multiplier has a first and second input, for receiving at the first input the transmitted signal, and provides, at an output, the product of the first and second input. The frequency estimator, is for receiving the output of the multiplier and for deriving an estimate of the frequency offset in the transmitted signal in accordance with the received multiplier output. The signal generator is for receiving the estimate of the frequency offset, for generating a sinusoidal signal having a frequency determined in accordance with the received frequency offset estimate, for feeding back the generated sinusoidal signal to the second input of the multiplier to correct the phase rotation of the transmitted signal received at the first input by rotating the transmitted signal in accordance with the generated sinusoidal signal.

In an embodiment of the first aspect of the present invention there is provided a filter, a symbol timing recovery unit and a matched filter. The filter is preferably a low pass filter for both receiving the output of the multiplier and for filtering out-of band noise from the output of the multiplier. The symbol timing recovery unit is for receiving the filtered output of the multiplier and for sampling its input to generate a resampled signal having a maximum eye opening in the output signal eye diagram. The matched filter is for receiving the resampled signal from the symbol timing recovery unit, for filtering out-of-band noise from the received resampled signal, and for providing the filtered resampled signal to the frequency estimator. In a further embodiment, the multiplier is a discrete multiplier, the filter is a discrete filter, the frequency estimator is a discrete estimator, the signal generator is a discrete signal generator, the symbol timing recovery unit is a is a discrete symbol timing recovery unit, and the matched filter is a square root raised cosine filter.

In further embodiments, the frequency estimator includes an amplitude based estimator, preferably having means to generate a filtered frequency offset estimate, and bias and slope determining means. The amplitude based estimator is for generating a frequency offset estimate in accordance with the amplitude of the in-phase and quadrature of the signal received by the frequency estimator, and preferably as

\hat{ƒ}_{c,raw}[n]=(I[n]−I[n−1])×Q[n]−(Q[n]−Q[n−1]×I[n]

where I[n] and Q[n] are the amplitudes of the in-phase and quadrature components of the input to the frequency estimator at discrete time index n. The means to generate a filtered frequency offset estimate preferably average a plurality of previous estimates with the current estimate to obtain a filtered frequency offset estimate. The bias and slope determining means are for determining the bias and slope as polynomials of a known symbol rate for the transmitted signal, and for generating a frequency offset estimate as a function of the filtered frequency offset, the bias and slope. In another presently preferred embodiment the signal generator includes a numerically controlled oscillator for generating a sinusoid signal whose frequency is the complex conjugate of the estimate of the frequency offset.

In a second aspect of the present invention there is provided a method for correcting a frequency offset in a received signal, the offset equivalent to a phase rotation. The method comprises the steps of initializing a frequency offset estimate signal to a multiplicative unity value; multiplying the received signal by the frequency offset estimate signal; estimating the frequency offset of the transmitted signal in accordance with the product of the received signal and the frequency offset estimate signal; generating a frequency offset estimate signal in accordance with the frequency offset estimate, the frequency offset estimate signal for rotating the received signal by the frequency offset estimate to correct the frequency offset in the received signal; and feeding back the frequency offset estimate signal to the step of multiplying the received signal by the frequency offset estimate signal.

Embodiments of the present invention further include the step of resampling the received signal prior to estimating the frequency offset, to generate a resampled signal having a maximum eye opening in the output signal eye diagram, the resampled signal for use in the step of estimating the frequency offset; filtering the resampled signal, prior to its use in the step of estimating the frequency offset, to reduce out-of-band noise; and filtering the product of the received signal and the frequency offset estimate signal, prior to its use in the step of resampling, to reduce out-of-band noise. In other embodiments the step of estimating the frequency offset includes generating the frequency offset estimate in accordance with the amplitude of the in-phase and quadrature of the product of the received signal and the frequency offset estimate signal, where preferably the frequency offset estimate is calculated as

\hat{ƒ}_{c,raw}[n]=(I[n]−I[n−1])×Q[n]−(Q[n]−Q[n−1]×I[n]

where I[n] and Q[n] are the amplitudes of the in-phase and quadrature components product of the received signal and the frequency offset estimate signal at discrete time index n. In some embodiments the step of estimating the frequency offset includes averaging a plurality of previous estimates with the current estimate to obtain a filtered frequency offset estimate, and preferably include calculating the frequency offset as a function of the filtered frequency offset, and the bias and slope polynomials of a known symbol rate associated with the received signal. In another embodiment, the step of generating a frequency offset estimate signal includes generating a signal having as its frequency the complex conjugate of the frequency offset estimate.

In a third aspect of the present invention, there is provided a frequency estimator for estimating the frequency offset of a received signal. The estimator comprises an amplitude based estimator for generating a frequency offset estimate in accordance with the amplitude of the in-phase and quadrature of the received signal. In embodiments of this aspect of the present invention the amplitude estimator includes means to generate the frequency offset estimate as

\hat{ƒ}_{c,raw}[n]=(I[n]−I[n−1])×Q[n]−(Q[n]−Q[n−1]×I[n]

where I[n] and Q[n] are the amplitudes of the in-phase and quadrature components of the input to the frequency estimator at discrete time index n, and preferably includes means to generate a filtered frequency offset estimate by averaging a plurality of previous estimates with the current estimate and further includes bias and slope determining means, for determining the bias and slope as polynomials of a known symbol rate for the transmitted signal, and for generating a frequency offset estimate as a function of the filtered frequency offset, the bias and slope.

Other aspects and features of the present invention will become apparent to those skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating an embodiment of the present invention;

FIG. 2 is a block diagram illustrating an embodiment of the present invention;

FIG. 3 is a flowchart illustrating an embodiment of the present invention;

FIG. 4 is a graph of the performance of an implementation of the frequency estimator of the present invention at a received symbol rate of 10 Mbaud;

FIG. 5 is a graph of the performance of an implementation of the frequency estimator of the present invention at a received symbol rate of 15 Mbaud;

FIG. 6 is a graph of the performance of an implementation of the frequency estimator of the present invention at a received symbol rate of 21.7 Mbaud;

FIG. 7 is a graph of the performance of an implementation of the frequency estimator of the present invention at a received symbol rate of 25 Mbaud;

FIG. 8 is a graph of the performance of an implementation of the frequency estimator of the present invention at a received symbol rate of 30 Mbaud; and

FIG. 9 is a graph of the calibration curve of an implementation of the frequency estimator of the present invention.

### DETAILED DESCRIPTION

Generally, the present invention provides a control circuit to estimate the frequency offset in a received signal, and then remove the offset.

It is common for the frequency offset detected in a channel to be relatively stable over short periods of time. Thus, if a frequency offset estimate is derived quickly, it can be applied to subsequently received segments of the received signal through the use of a feedback loop. If the estimate is inaccurate it will simply result in a signal having a different offset, and typically the new offset is smaller in magnitude than the original offset. Such a feedback system provides an immediate reduction in the offset, so long as the error in the first estimate of the offset is greater than the magnitude of the offset itself.

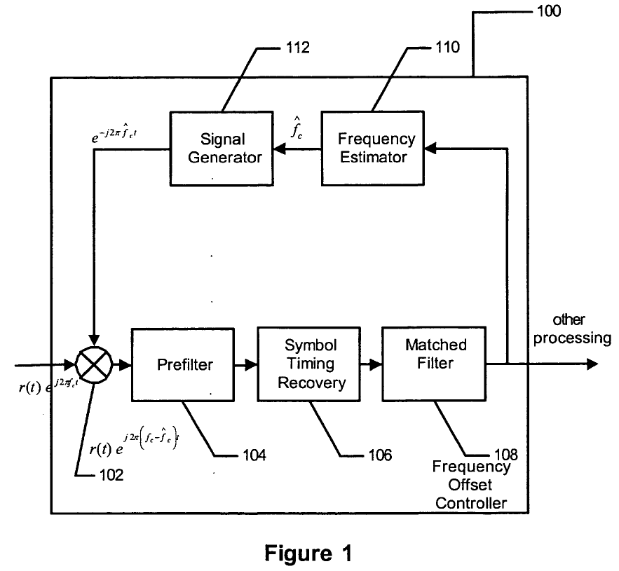

FIG. 1 illustrates a system according to an embodiment of the present invention. A signal r(t) is transmitted through a channel to a receiver. During transmission, the signal r(t) is frequency offset. The frequency offset is modelled as a phase rotation, which is expressed as multiplication by e^{j2πƒ}^{_{c}}^{t}. The signal, as received, is of the form r(t)e^{j2πƒ}^{_{c}}^{t}, where r(t) is the complex valued information bearing transmitted signal, ƒ_{c} is the frequency offset in Hz, and j is the imaginary number. In the receiver, this received signal is passed to frequency offset controller 100. One skilled in the art will appreciate that the frequency offset can be expressed in other forms which would require the offset representation to be altered accordingly. For the purposes of the following discussion, the above described representation will be used, but should not be considered limiting to the scope of the present invention.

The offset signal is received in the frequency offset controller 100 by a first input of multiplier 102, and the output of multiplier is provided to prefilter 104. Prefilter 104 is preferably implemented as a lowpass filter selected or designed to reduce or eliminate excessive out-of-band noise. Symbol timing recovery (STR) unit 106 resamples the prefiltered signal to achieve maximum eye opening in the output signal eye diagram. Techniques to achieve symbol timing recovery are known in the art, and one skilled in the art will readily appreciate that the exact characteristics may be implementation specific and derived by any of a number of methods. The output of the STR unit 106 is further filtered by matched filter 108 to reduce or remove out-of-band noise. One skilled in the art will appreciate that any of a number of filter designs, including a band pass filter, can be employed. The output of matched filter 108 is the output frequency offset controller 100, and is typically subject to other processing in the receiver.

To correct the frequency offset, the output of matched filter 108 is used in a feedback loop. In the feedback loop, the output of matched filter 108 to estimate the frequency offset, which in turn is used to correct the incoming signal. The output of matched filter 108 is the input signal to frequency estimator 110, which produces an estimate, \hat{ƒ}_{c}, of the frequency offset in the received signal. This estimate is then passed to the signal generator 112. Signal generator 112 produces a signal, in accordance with the frequency estimate, that fed back by sending it to multiplier 102. Multiplier 102 then multiplies the generated signal and the received signal. In a presently preferred embodiment, the output of the signal generator is a complex valued sinusoid with frequency −\hat{ƒ}_{c}, the complex conjugate of the frequency estimate. For ease of implementation, the signal generator preferably provides a signal that can be modelled or represented as e^{-j2π\hat{ƒ}}^{_{c}}^{t}. When this signal is provided to multiplier 102, the result will be r(t)e^{(j2πƒ}^{_{c}}^{t)-(j2π\hat{ƒ}}^{_{c}}^{t)}=r(t)e^{j2π(ƒ}^{_{c}}^{-\hat{ƒ}}^{_{c}}^{)t}. As \hat{ƒ}_{c} aches ƒ_{c} this value will converge to r(t), the unoffset complex valued information bearing signal. Upon initialisation of the frequency offset controller 100, frequency estimator 110 provides a frequency estimate of \hat{ƒ}_{c}=0, which results in a multiplicative unity signal, and as a result multiplier 102 provides as its output the same signal it receives. Frequency estimator 110 preferably derives \hat{ƒ}_{c} in accordance with both the output of matched filter 108 and the previous estimate, so that the estimated offset does not disappear as the offset is corrected. One skilled in the art will appreciate that this compensation can be achieved through either estimator 110 or signal generator 112, and will also appreciate that the implementation of such a design is well understood in the art.

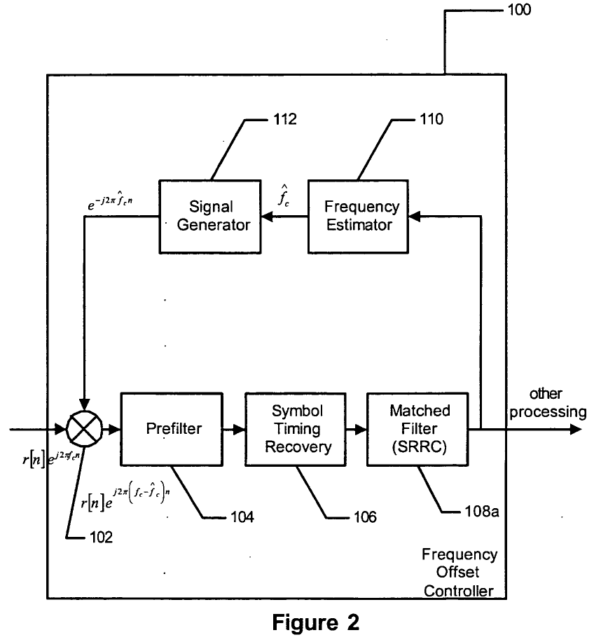

FIG. 2 illustrates a discrete implementation of the present invention. The components of the system are similar to those described for the continuous system, but are preferably designed to operate on a discrete sequence of samples. As in the continuous system, a signal is transmitted through a channel to a receiver. The transmitted signal is represented by the sequence r[n]. During transmission, the signal r[n] is frequency offset. The frequency offset is again modelled as a phase rotation, which is expressed in the discrete plane as multiplication by e^{j2πƒ}^{_{c}}ⁿ. The signal as received is r[n]e^{j2πƒ}^{_{c}}ⁿ,where r[n] is the discrete complex valued information bearing transmitted signal. This received signal is passed to frequency offset controller 100.

The received sequence is handled by multipler 102, prefilter 104. STR unit 106 as described above, though the operations performed are discrete. The output of the STR unit 106 is further filtered by discrete matched filter 108a to reduce or remove out-of-band noise. In a presently preferred embodiment, a square-root raised cosine filter (SRRC) is used for discrete matched filter 108a. An SRRC is presently preferred due to its common use in a plurality of other communications systems. The output of discrete matched filter 108a is also used in the feedback loop as the input signal to frequency estimator 110, which produces an estimate, \hat{ƒ}_{c}, of the frequency offset in the received signal. This estimate is then passed to the signal generator 112. Signal generator 112 produces a discrete signal in accordance with the frequency estimate that is passed to multiplier 102 In a presently preferred embodiment, the output of the signal generator is a discrete complex valued sinusoid with frequency −\hat{ƒ}_{c}. For ease of implementation, the signal generator preferably provides a signal that can be modelled or represented as e^{-j2π\hat{ƒ}}^{_{c}}ⁿ. When this signal is provided to multiplier 102, the result will be r[n]e^{(j2πƒ}^{_{c}}^{n)-(j2π\hat{ƒ}}^{_{c}}ⁿ⁾=r[n]e^{j2π(ƒ}^{_{c}}^{-\hat{ƒ}}^{_{c}}⁾ⁿ. As \hat{ƒ}_{c} approaches ƒ_{c} this value will converge to r[n], the unoffset complex valued information bearing sequence. Upon initialisation of the frequency offset controller 100, frequency estimator 110 provides a frequency estimate of \hat{ƒ}_{c}=0, which results in a discrete complex sinusoid without a frequency, and as a result multiplier 102 provides as its output the same signal it receives. Frequency estimator 110 preferably derives \hat{ƒ}_{c} in accordance with both the output of discrete matched filter 108a and the previous estimate, so that the estimated offset does not disappear as the offset is corrected. One skilled in the art will appreciate that this compensation can be achieved through either estimator 110 or signal generator 112, and will also appreciate that the implementation of such a design is well understood in the art.

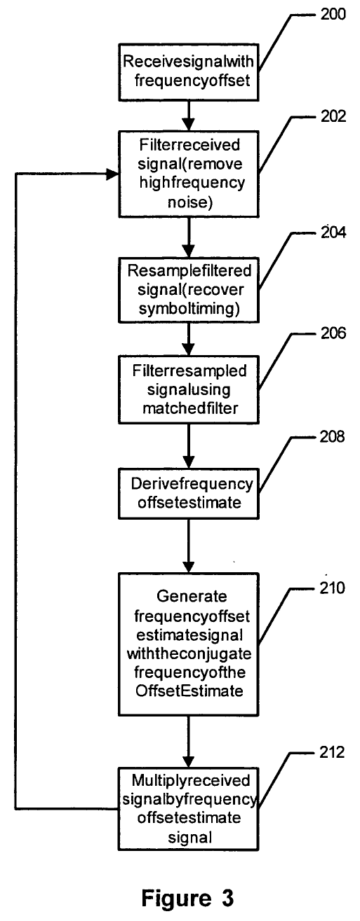

FIG. 3 illustrates a method of frequency offset correction according to an embodiment of the present invention. In a first step 200 signal having a frequency offset is received. In step 202, the received signal is preferably filtered to remove high frequency noise out of the a priori known band. The filtered signal is then resampled in step 204 to recover symbol timing and derive a resampled signal that has a maximum eye opening. The resampled signal is preferably provided to a further filter, for matched filtering in step 206. Step 206 preferably performs a band pass function and removes noise both above and below the desired band, and in a discrete system can be performed through a process of square root raised cosine filtering. The filtered signal is provided to a frequency offset estimator in step 208, whereupon an estimate of the frequency offset is derived using characteristics of the filtered signal. The estimate of the frequency offset is used in step 210 to generate a signal having a frequency that is the conjugate of the frequency offset derived in step 208. In step 212 the incoming offset signal is multiplied by the signal generated in step 210 to correct the offset in the incoming signal. The process can be continued using the corrected signal to achieve a convergence between the frequency offset and the estimated frequency offset. One skilled in the art will appreciate that the above method can be preceded by a step of generating a multiplicative unity signal so that the incoming signal is unchanged during initialization.

In one embodiment of the present invention there is further provided a novel mechanism for estimating the frequency offset. Where the prior art relied upon inherently recursive methods for estimating the error, or methods that relied upon the availability of at least one of high computational power and large amounts of memory, in a presently preferred embodiment of the present invention the frequency offset estimation is performed through a single function, without requiring heavy resources. The feedback structure described above in conjunction with FIGS. 1 and 2 provide a mechanism for allowing a frequency offset estimate to be refined without requiring that the estimation method be recursive itself.

Frequency estimator 110 preferably utilises the amplitude of both the in-phase and the quadrature components of the signal it receives. In the discrete system of FIG. 2, the estimator 110 preferably subtracts the product of the amplitude of the in-phase component of the present symbol and the difference in the amplitude of the quadrature component of the present symbol and the amplitude of the quadrature component of the previous symbol, from the product of the amplitude of the quadrature component of the present symbol and the difference between the amplitude of the in-phase component of the previous symbol and the amplitude of the in-phase component of the previous symbol. One skilled in the art will appreciate that if I[n] and Q[n] are the respective amplitudes of the in-phase and quadrature components of the received signal at discrete time index n, the estimate of the frequency offset in the discrete system can be expressed as

\hat{ƒ}_{c,raw}[n]=(I[n]−I[n−1])×Q[n]−(Q[n]−Q[n−1]×I[n]

In a presently preferred embodiment, the metric is updated every symbol period for both increased accuracy, and to ensure the minimum amount of time required for convergence. Unfortunately, due to the rapid updating of the metric, the estimate is often noisy due to the noise inherent in the received signal. To avoid the rapid changes in the estimate, which are a function of noise more than a change in the offset of the received signal, the estimate is preferably filtered to remove high frequency noise, which as one skilled in the art will appreciate can be achieved using a low-pass filter.

In an alternate embodiment, the above estimate is filtered using a sliding window average. The averaging of the estimated offset serves to steady the signal and reduce the high frequency noise. In a presently preferred embodiment of this embodiment of the invention, the sliding window size is 2048 symbols. The estimate of the frequency offset provided to the signal generator 112 by estimator 110 is expressed as

$${\hat{f}}_{c , filtered} [ n ] = \frac{1}{2048} {\sum }_{n = 0}^{2048} {\hat{f}}_{c , raw} [ - n ] .$$

One skilled in the art will appreciate that the use of prefilter 104, STR unit 106 and matched filter 108 and 108a, are merely preferred embodiments of the present invention. The use of these three elements provide a signal that is more suitable for use in the frequency estimator due to their removal of excess out-of-band noise and the reconstruction of the signal performed by STR unit 106. A minimal embodiment of the present invention includes multiplier 102 for receiving the signal, and providing its output to frequency estimator 110, which derives a frequency estimate based on the raw signal, and provides the estimate to signal generator 112. Signal generator 112 generates the complex sinusoid that is multiplied with the received signal in multiplier 102 to correct the frequency offset. In this minimal embodiment it is presently preferred that frequency estimator 110 employ a sliding window average to filter the changes in the estimate of the offset.

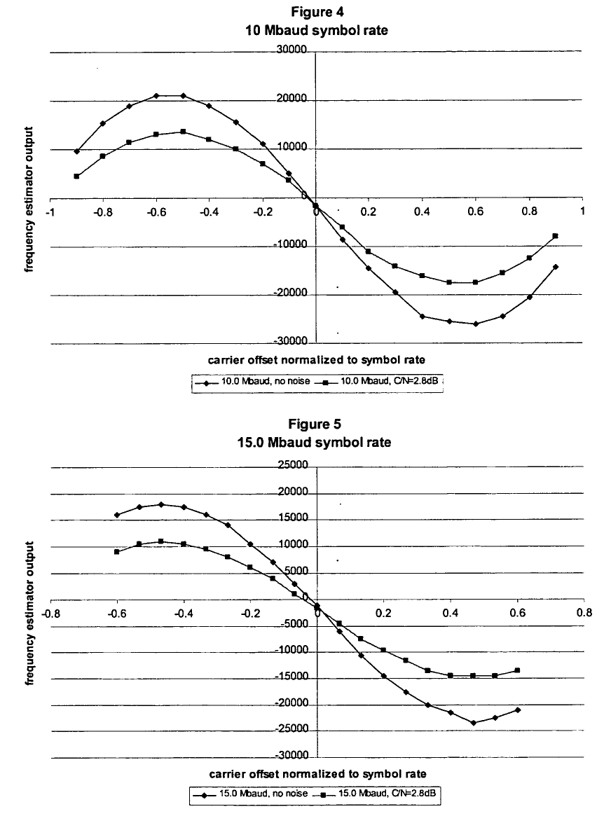

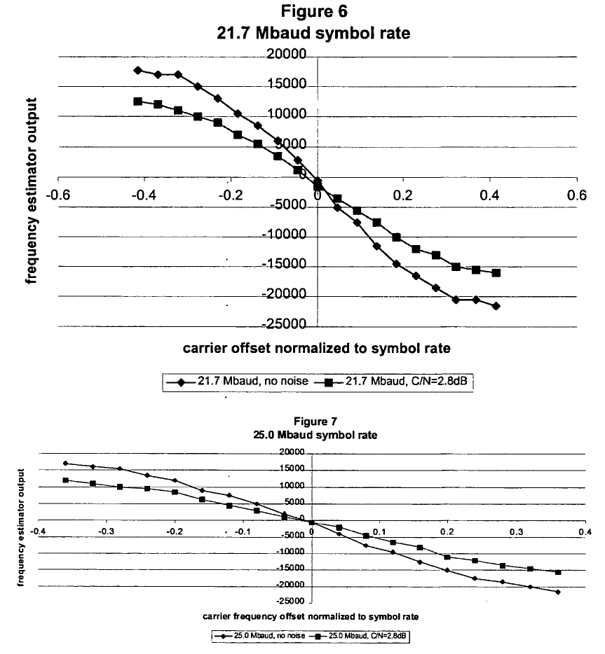

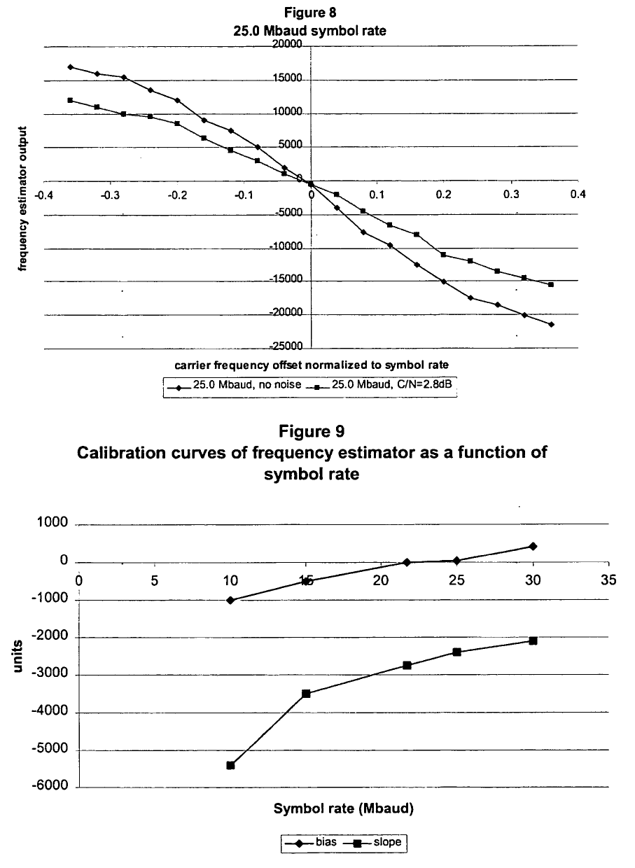

The performance of this embodiment of the frequency estimator at 10, 15, 21.7, 25, and 30 Mbaud is shown in FIGS. 4-8 respectively. The actual units of measurement at the output of the frequency estimator are unique to the tested implementation; however the variation in output as a function of carrier offset is significant. Although the slope of the curve varies as a function of the carrier-to-noise ratio of the received signal, a best-fit curve can be drawn between the two performance extremes to obtain a useful calibration curve. This calibration curve is reasonably accurate for carrier offsets below 25% of the symbol rate, and less accurate, but still useful, for offsets between 25% and 50% of the symbol rate. There is also a fixed bias present, which is a function of the symbol rate. FIG. 9 shows a summary of the slope and bias of the calibration curves as a function of symbol rate. In order to obtain an estimate of the slope and bias at other symbol rates, a numerical interpolation between the points in FIG. 9 can be performed. One skilled in the art will appreciate that different physical implementations of systems of the present invention may result in different performance and calibration curves, but the uses for the data in these different curves will be similar to the uses outlined herein.

For the results of the tested systems, a fourth order Lagrange polynomial was used for curve fitting. Because there are five data points, a fourth order polynomial passes exactly through each point. The interpolating polynomial for the slope is

slope=−2.488×10⁴+3.854×10³ ƒ_{sym}−2.616×10² ƒ_{sym}²+8.010 ƒ_{sym}³−9.095×10⁻² ƒ_{sym}⁴,

and the interpolating polynomial for the bias is

bias=3.451×10³−1.270×10³ ƒ_{sym}+1.223×10² ƒ_{sym}²−4.581 ƒ_{sym}³+6.010×10⁻² ƒ_{sym}⁴,

where ƒ_{sym} is the symbol rate in MHz. The polynomials are valid for symbol rates between 10 and 30 Mbaud. The estimate of the frequency offset, in MHz, is then given by

$${\hat{f}}_{c} = \frac{{\hat{f}}_{c , filtered} - bias}{slope} .$$

In a presently preferred embodiment, the signal generator is a numerically-controlled oscillator (NCO), which is well known in the art. Once \hat{ƒ}_{c} has been calculated, the NCO is programmed to generate a sinusoid having a frequency of −\hat{ƒ}_{c}.

The embodiments described above are beneficial because they provide an all-digital automatic frequency estimation and correction architecture; they automatically estimate and correct the frequency offset; they can effectively estimate and remove frequency offsets of up to 25% of the received symbol rate, with an error less than 5% of the received symbol rate; and they can roughly estimate and reduce frequency offsets that are between 25% and 50% of the received symbol rate.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A frequency offset controller for correcting a frequency offset in a transmitted signal, the offset equivalent to a phase rotation of the transmitted signal, the controller comprising:
a multiplier having a first and second input, for receiving at the first input the transmitted signal, and for providing at an output the product of the first and second input;
a frequency estimator, for receiving the output of the multiplier, for deriving an estimate of the frequency offset in the transmitted signal in accordance with the received multiplier output; and
a signal generator, for receiving from the frequency estimator the estimate of the frequency offset, for generating a sinusoidal signal having a frequency determined in accordance with the received frequency offset estimate, for feeding back the generated sinusoidal signal to the second input of the multiplier to correct the phase rotation of the transmitted signal received at the first input by rotating the transmitted signal in accordance with the generated sinusoidal signal.

2. The controller of claim 1, further including a symbol timing recovery unit for receiving the output of the multiplier, for sampling the output of the multiplier, for generating a resampled signal having a maximum eye opening in the output signal eye diagram in accordance with the sampled output of the multiplier, and for providing the resampled signal to the frequency estimator.

3. The controller of claim 2, further including a matched filter for receiving the resampled signal from the symbol timing recovery unit, for filtering out-of-band noise from the received resampled signal, and for providing the filtered resampled signal to the frequency estimator.

4. The controller of claim 3, wherein the multiplier is a discrete multiplier, the frequency estimator is a discrete estimator, the signal generator is a discrete signal generator the symbol timing recovery unit is a is a discrete symbol timing recovery unit, and the matched filter is a square root raised cosine filter.

5. The controller of claim 3, further including a filter for receiving the output of the multiplier, for filtering out-of band noise from the output of the multiplier, and for providing the filtered output of the multiplier to the symbol timing recovery unit.

6. The controller of claim 5 wherein the filter is a low pass filter.

7. The controller of claim 1 wherein the frequency estimator includes an amplitude based estimator for generating a frequency offset estimate in accordance with the amplitude of the in-phase and quadrature of the signal received by the frequency estimator.

8. The controller of claim 7, wherein the amplitude estimator includes means to generate the frequency offset estimate as
\hat{ƒ}_{c,raw}[n]=(I[n]−I[n−1])×Q[n]−(Q[n]−Q[n−1]×I[n]
where I[n] and Q[n] are the amplitudes of the in-phase and quadrature components of the input to the frequency estimator at discrete time index n.

9. The controller of claim 7 wherein the amplitude estimator includes means to generate a filtered frequency offset estimate by averaging a plurality of previous estimates with the current estimate.

10. The controller of claim 9, wherein the frequency estimator includes bias and slope determining means, for determining the bias and slope as polynomials of a known symbol rate for the transmitted signal, and for generating a frequency offset estimate as a function of the filtered frequency offset, the bias and slope.

11. The controller of claim 1, wherein the signal generator includes a numerically controlled oscillator for generating a sinusoid signal whose frequency is the complex conjugate of the estimate of the frequency offset.

12. A method for correcting a frequency offset in a received signal, the offset equivalent to a phase rotation, the method comprising:
initializing a frequency offset estimate signal to a multiplicative unity value;
multiplying the received signal by the frequency offset estimate signal;
estimating the frequency offset of the transmitted signal in accordance with the product of the received signal and the frequency offset estimate signal;
generating a frequency offset estimate signal in accordance with the frequency offset estimate, the frequency offset estimate signal for rotating the received signal by the frequency offset estimate to correct the frequency offset in the received signal; and
feeding back the frequency offset estimate signal to the step of multiplying the received signal by the frequency offset estimate signal.

13. The method of claim 12 including the step of resampling the received signal prior to estimating the frequency offset, to generate a resampled signal having a maximum eye opening in the output signal eye diagram, the resampled signal for use in the step of estimating the frequency offset.

14. The method of claim 13 including the step of filtering the resampled signal, prior to its use in the step of estimating the frequency offset, to reduce out-of-band noise.

15. The method of claim 14 including the step of filtering the product of the received signal and the frequency offset estimate signal, prior to its use in the step of resampling, to reduce out-of-band noise.

16. The method of claim 12 wherein the step of estimating the frequency offset includes generating the frequency offset estimate in accordance with the amplitude of the in-phase and quadrature of the product of the received signal and the frequency offset estimate signal.

17. The method of claim 16, wherein the step of estimating the frequency offset includes calculating the frequency offset estimate as
\hat{ƒ}_{c,raw}[n]=(I[n]−I[n−1])×Q[n]−(Q[n]−Q[n−1]×I[n]
where I[n] and Q[n] are the amplitudes of the in-phase and quadrature components product of the received signal and the frequency offset estimate signal at discrete time index n.

18. The method of claim 17 wherein the step of estimating the frequency offset includes averaging a plurality of previous estimates with the current estimate to obtain a filtered frequency offset estimate.

19. The method of claim 18 wherein the step of estimating the frequency offset includes calculating the frequency offset as a function of the filtered frequency offset, and the bias and slope polynomials of a known symbol rate associated with the received signal.

20. The method of claim 12 wherein the step of generating a frequency offset estimate signal includes generating a signal having as its frequency the complex conjugate of the frequency offset estimate.

21. A frequency estimator for estimating the frequency offset of a received signal, the estimator comprising:
an amplitude based estimator for generating a frequency offset estimate in accordance with the amplitude of the in-phase and quadrature of the received signal.

22. The frequency estimator of claim 21 wherein the amplitude estimator includes means to generate the frequency offset estimate as \hat{ƒ}_{c,raw}[n]=(I[n]−I[n−1])×Q[n]−(Q[n]−Q[n−1]×I[n] where I[n] and Q[n] are the amplitudes of the in-phase and quadrature components of the input to the frequency estimator at discrete time index n.

23. The frequency estimator of claim 22 wherein the amplitude estimator includes means to generate a filtered frequency offset estimate by averaging a plurality of previous estimates with the current estimate.

24. The controller of claim 23, further including bias and slope determining means, for determining the bias and slope as polynomials of a known symbol rate for the transmitted signal, and for generating a frequency offset estimate as a function of the filtered frequency offset, the bias and slope.
